(19) United States
(12) Patent Application Publication
(10) Pub. No.: US 2021/0195911 A1
(43) Pub. Date: Jul. 1, 2021

(54) Kit and Method for Making a Smash Cake

(71) Applicant: Alanna DiNardo, Fairfield, NJ (US)

(72) Inventor: Alanna DiNardo, Fairfield, NJ (US)

(21) Appl. No.: 17/138,442

(22) Filed: Dec. 30, 2020

Related U.S. Application Data
(60) Provisional application No. 62/955,194, filed on Dec. 30, 2019.

(51) Int. Cl. A23G 3/20; A23G 3/54; A23G 3/34

(52) U.S. Cl. CPC A23G 3/2023; A23G 3/545; A23G 2220/22; A23G 3/0029; A23G 3/343

(57) ABSTRACT

A kit and method of use thereof are provided for making a smash cake. The kit includes a mallet, at least one mold, a quantity of shell-making material, and a plurality of confectioneries. Additionally, the kit may include at least one plate. The mallet allows a user to smash the smash cake. The at least one mold allows a cake shell to be formed. The quantity of shell-making material is used to create a cake shell of the smash cake. The plurality of confectioneries may be cookies, candies, and the like. The plurality of confectioneries is used to fill the smash cake. The quantity of shell-making material is poured about the at least one mold and then hardened into a cake shell. The cake shell is filled with the plurality of confectioneries and then placed on the at least one plate. The smash cake is then smashed with the mallet.

The current application claims a priority to the U.S. Provisional Patent application Ser. No. 62/955,194 filed on Dec. 30, 2019.

### FIELD OF THE INVENTION

The present invention relates generally to self-help kits. More specifically, the present invention is a kit and method for making smash cakes. The present invention allows a user to create a smash cake with ease by using the kit provided by the present invention. The present invention is specifically designed for preparing smash cakes. However, the present invention is not limited to this option, and it may further be adapted to prepare different kinds of cakes.

### BACKGROUND OF THE INVENTION

For ages, cakes have been a form of food that is widely utilized to celebrate special occasions such as birthdays, holidays, baby showers, weddings, bridal showers, anniversaries, graduations, engagements, and the like. Generally, a traditional cake is prepared using flour, a sweetening agent such as sugar, a binding agent such as an egg, fat such as butter, and some sort of leavening agents such as yeast and baking powder. The cake is often decorated for enhancing the appearance and the taste of the cake. Further, the cake can also be decorated based on the theme of the occasion.

A smash cake is a unique alternative to a traditional cake. Usually, the smash cake comprises a dome-shaped shell of chocolate that can be smashed with a special hammer or mallet to reveal the candies inside the dome. The smash cake can be decorated with a wide variety of designs suitable for a variety of occasions. Making a smash cake requires some specifically-designed supplies, and purchasing baking ingredients is tedious and cumbersome. Specialists, such as cake shops and bakeries, offer pre-made smash cakes to their customers. People are forced to purchase expensive smash cakes from these shops and bakeries for their special occasions since no kits for making smash cakes are available in the market. The present invention aims to solve some of these problems by disclosing a kit for the preparation of smash cakes.

### BRIEF DESCRIPTION OF THE DRAWINGS

FIG. 1 is a diagram illustrating the system of the present invention.

FIG. 2 is a flowchart illustrating the overall process for the method of the present invention.

FIG. 3 is a flowchart illustrating the subprocess on melting the quantity of shell-making material into the liquid state.

FIG. 4 is a flowchart illustrating the subprocess of making a rigid cake shell of the smash cake.

FIG. 5 is a flowchart illustrating the subprocess of including at least one themed item for the smash cake.

FIG. 6 is a flowchart illustrating the subprocess of packaging and transporting the mallet, the mold, the quantity of shell-making material, and the plurality of confectioneries.

FIG. 7 is a flowchart illustrating the subprocess of including a plurality of edible decorations for the smash cake.

### DETAIL DESCRIPTIONS OF THE INVENTION

All illustrations of the drawings are for the purpose of describing selected versions of the present invention and are not intended to limit the scope of the present invention.

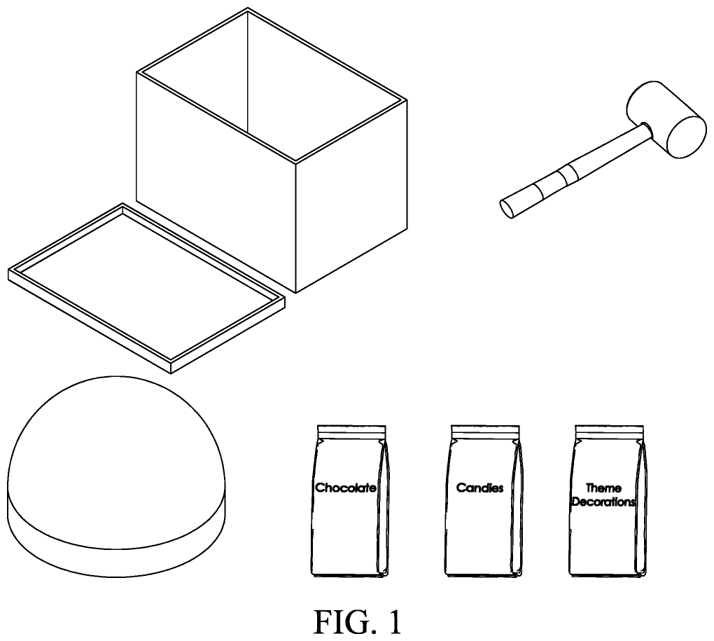

In reference to FIGS. 1 through 7, the present invention is a kit and method for making a smash cake. It is an aim of the present invention to provide a kit for preparing and decorating a smash cake for a predetermined special occasion such as a birthday, a holiday, a wedding, an anniversary, an engagement, a graduation, a baby shower, a bridal shower, and the like. With reference to FIG. 1, the kit includes a mallet, at least one mold, a quantity of shell-making material, and a plurality of confectioneries. Additionally, the kit may include at least one plate or a user may provide the at least one plate from his or her own household. The mallet allows a user to break open the smash cake after the smash cake is prepared. The mallet can be made from various material such as, but not limited to, wood or plastic material. The at least one mold allows a cake shell to be formed into a particular shape. The quantity of shell-making material is used to make the cake shell of the smash cake. The quantity of shell-making material may be any type of sweet and edible material that can be melted and then hardened at room temperature. The quantity of shell-making material is preferably a chocolate material. The plurality of confectioneries may be any type of edible sweets such as, but not limited to, cookies, candies, and the like. Each of the plurality of confectioneries may be configured to have a shape of an animal, a doll, a cartoon character, a castle, a locomotive, a vehicle, a human, a string, a candle, and the like. The type of confectionery can be selected based on at least one flavor, at least one color, or a combination thereof. The plurality of confectioneries is used to fill the smash cake.

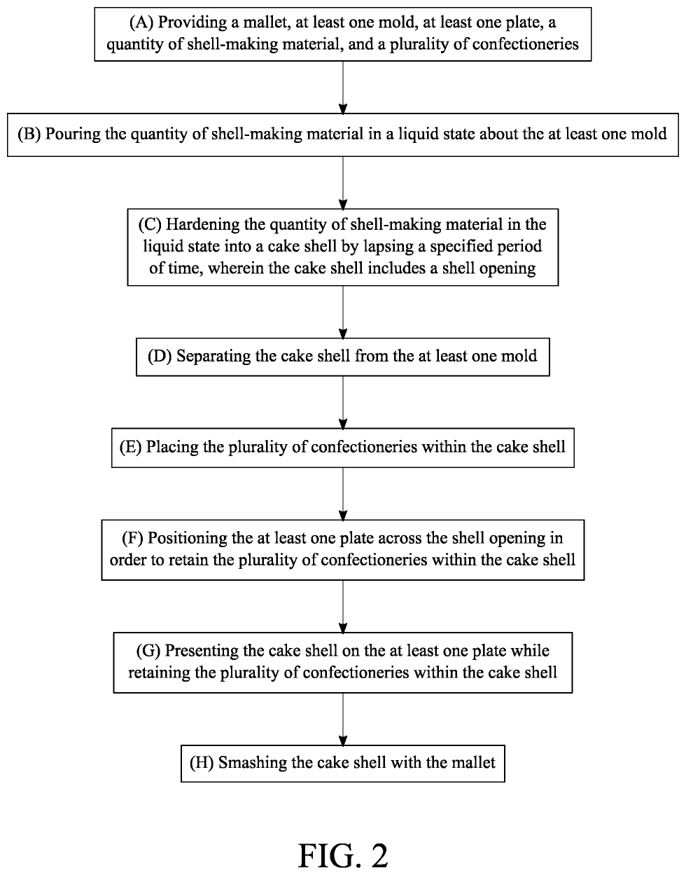

The method of the present invention follows an overall process for making a smash cake. With reference to FIG. 2, the quantity of shell-making material in a liquid state is poured about the at least one mold (Step B). In more detail, the quantity of shell-making material conforms to the shape of the mold when poured about the at least one mold. The quantity of shell-making material in the liquid state is hardened into a cake shell by lapsing a specified period of time (Step C). Thus, the quantity of shell-making material hardens to a solid state at room temperature so that the inner surface of the cake shell takes on the specific shape of the outer surface of the mold and so that the outer surface of the cake shell takes on the general shape of the mold. The specified period of time is relative to the environment where the quantity of shell-making material and the at least one mold are positioned. For example, the specific period of time is decreased if the quantity of shell-making material and the at least one mold are positioned inside of a refrigerator. Moreover, the cake shell includes a shell opening which would be located at the bottom of the cake shell based on how the cake shell is formed about the mold. The shell opening allows the cake shell to be filled. The cake shell is then separated from the at least one mold (Step D). Thus, the main structure of the smash cake is prepared. The plurality of confectioneries is placed within the cake shell (Step E) by flipping the cake shell to an upside-down position and filling the cake shell with the plurality of confectionaries through the shell opening. This arrangement allows for the concealment of the plurality of confectioneries. The at least one plate is positioned across the shell opening in order to retain the plurality of confectioneries within the cake shell (Step F). Thus, this arrangement prevents the plurality of confectioneries from falling out of the cake shell and from being visible to users. The cake shell is presented on the at least one plate while retaining the plurality of confectioneries within the cake shell (Step G) by flipping the cake shell with the plate back to an upright position. Thus, the smash cake is ready to be safely smashed by a user. Finally, the cake shell is smashed with the mallet (Step H). This step exposes the plurality of confectioneries within the cake shell so that different people can see and grab the plurality of confectionaries for consumption as well as see and grab the broken pieces of the cake shell for consumption.

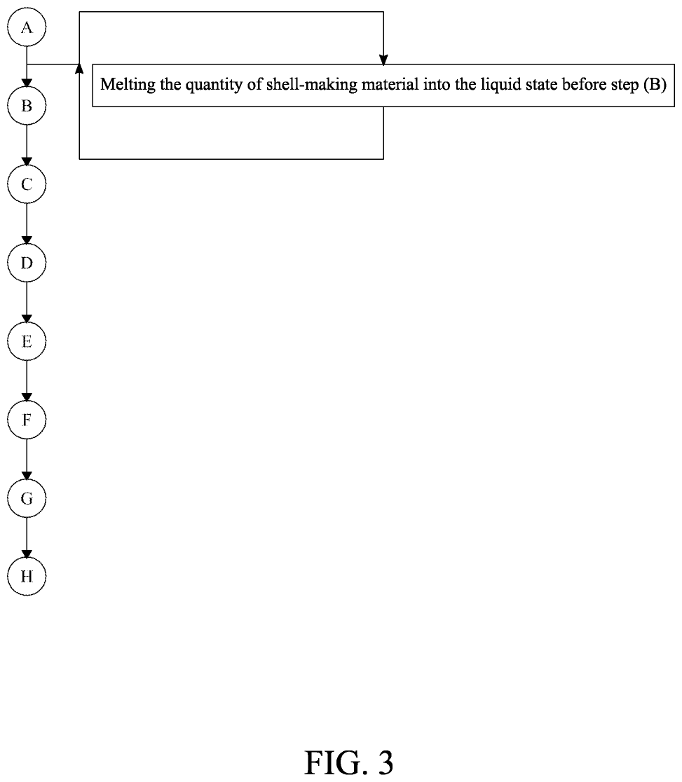

In order for the quantity of shell-making material to be in a liquid state and with reference to FIG. 3, the following subprocess is executed. The quantity of shell-making material is melted into the liquid state before Step B. In more detail, the quantity of shell-making material is preferably melted into the liquid state by heating the quantity of shell-making material on a stove.

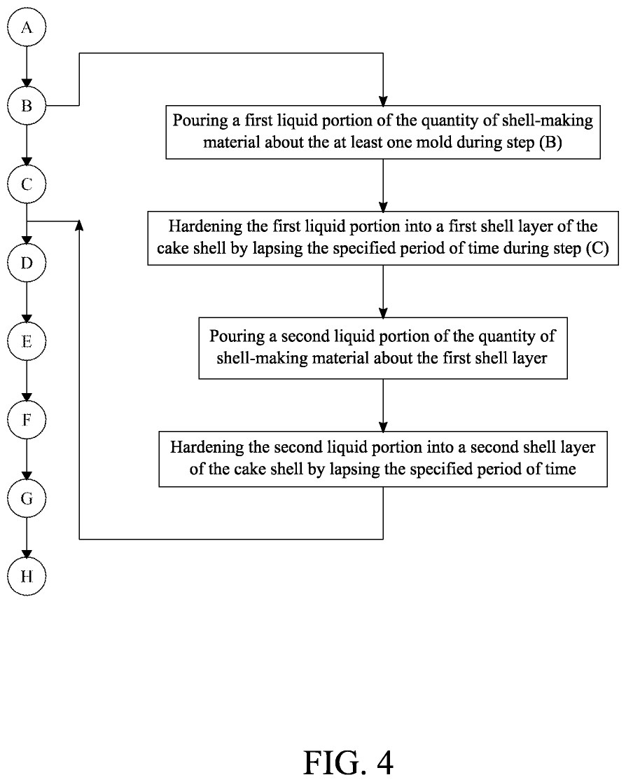

In order for the cake shell to be rigid enough to not easily break when preparing the smash cake and with reference to FIG. 4, the following subprocess is executed. A first liquid portion of the quantity of shell-making material is poured about the at least one mold during Step B. This step allows the first liquid portion of the quantity of shell-making material to conform to the external shape of the at least one mold. The first liquid portion then is hardened into a first shell layer of the cake shell by lapsing a specified period of time during Step C. Thus, one layer of the cake shell is formed. A second liquid portion of the quantity of shell-making material is poured about the first shell layer. This step allows the second liquid portion of the quantity of shell-making material for conform to the external shape of the first shell layer. The second liquid portion is hardened into a second shell layer of the cake shell by lapsing the specific period of time. Thus, another layer of the cake shell is formed assuring that the cake shell is rigid enough to not break easily during preparation of the smash cake.

The at least one mold can be various shapes that can be filled. The at least one mold is preferably a hemispherical shape. The hemispherical shape allows the smash cake to be easily smashed by the mallet by a user by focusing on a dome portion of the hemispherical shape. Further, the shell opening is positioned at a flat base of the hemispherical shape. The at least one mold may be made from any suitable material, including but not limited to aluminum, stainless steel, or the like.

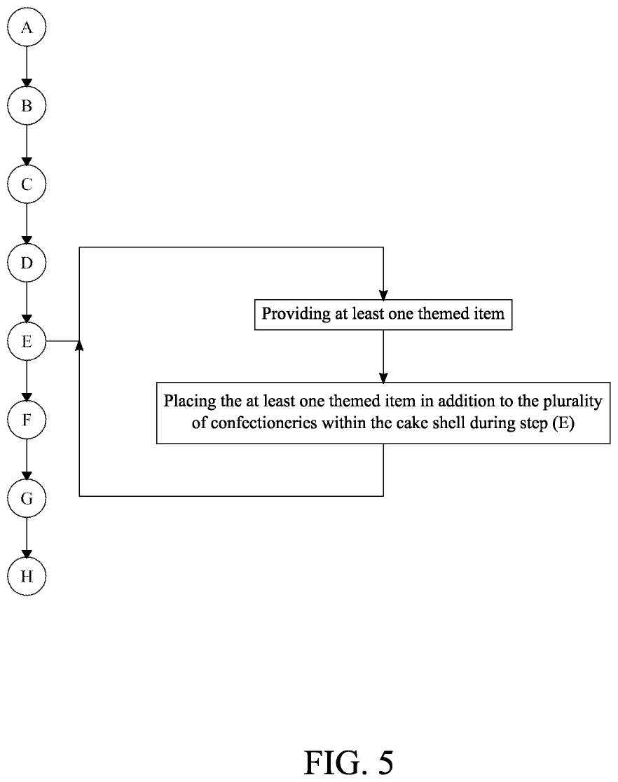

With reference to FIG. 5, the kit of the present invention may be further provided with at least one themed item. The at least one themed item may be a toy or an edible figure that is related to a theme that a consumer chooses when purchasing one iteration of the present invention. For example, the at least one themed item can be used to symbolize a theme of a festival, a holiday, an event, and the like. The at least one themed item is placed in addition to the plurality of confectioneries within the cake shell during Step E. Thus, the at least one themed item is concealed along with the plurality of confectioneries.

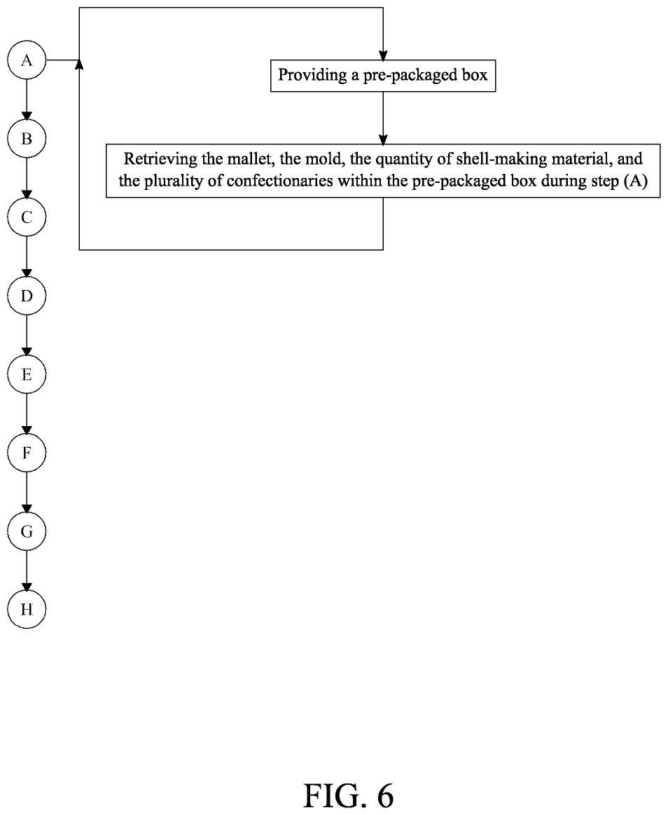

In order to package and transport the kit of the present invention and with reference to FIG. 6, the present invention may be further provided with a pre-packaged box. The mallet, the mold, the quantity of shell-making material, and the plurality of confectioneries is retrieved within the pre-packaged box during Step A. Thus, the mallet, the mold, the quantity of shell-making material, and the plurality of confectioneries is protected by the pre-packaged box. Further, the quantity of shell-making material may be positioned within a first container in order to further protect the quantity of shell-making material. Similarly, the plurality of confectioneries may be positioned within a second container in order to further protect the plurality of confectioneries.

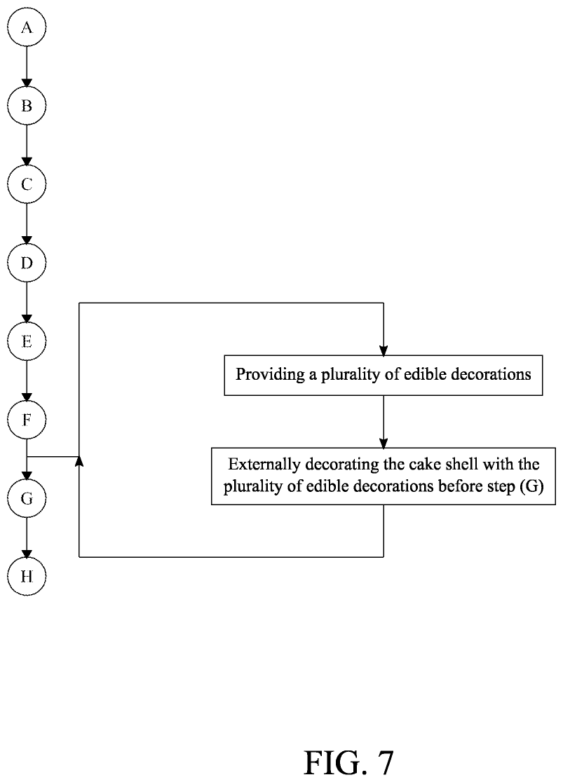

With reference to FIG. 7, the kit of the present invention may be further provided with a plurality of edible decorations. The plurality of edible decorations is preferably related to the theme that is chosen by the consumer when purchasing one iteration of the present invention. The plurality of edible decorations may be shaped sweets or icing that is used to externally decorate the cake shell before Step G.

The present invention may be further provided with a supplemental box that contains another plurality of shell-making material (i.e., chocolate), another plurality of confectioneries, theme decorative items, or a combination thereof for making additional smash cakes. In this way, the at least one mold and the mallet included in the outer packaging enclosure can be reused. The supplemental box can be sold together with or separate from the kit of the present invention.

Although the invention has been explained in relation to its preferred embodiment, it is to be understood that many other possible modifications and variations can be made without departing from the spirit and scope of the invention as hereinafter claimed.

What is claimed is:

1. A method for making a smash cake, the method comprises the steps:
(A) providing a mallet, at least one mold, at least one plate, a quantity of shell-making material, and a plurality of confectioneries;
(B) pouring the quantity of shell-making material in a liquid state about the at least one mold;
(C) hardening the quantity of shell-making material in the liquid state into a cake shell by lapsing a specified period of time, wherein the cake shell includes a shell opening;
(D) separating the cake shell from the at least one mold;
(E) placing the plurality of confectioneries within the cake shell;
(F) positioning the at least one plate across the shell opening in order to retain the plurality of confectioneries within the cake shell;
(G) presenting the cake shell on the at least one plate while retaining the plurality of confectioneries within the cake shell; and
(H) smashing the cake shell with the mallet.

2. The method for making a smash cake, the method as claimed in claim 1 comprises the step:
melting the quantity of shell-making material into the liquid state before step (B).

3. The method for making a smash cake, the method as claimed in claim 1 comprises the steps:
pouring a first liquid portion of the quantity of shell-making material about the at least one mold during step (B);
hardening the first liquid portion into a first shell layer of the cake shell by lapsing the specified period of time during step (C);
pouring a second liquid portion of the quantity of shell-making material about the first shell layer; and
hardening the second liquid portion into a second shell layer of the cake shell by lapsing the specified period of time.

4. The method for making a smash cake, the method as claimed in claim 1, wherein the quantity of shell-making material being a chocolate material.

5. The method for making a smash cake, the method as claimed in claim 1, wherein the at least one mold is a hemispherical shape, and wherein the shell opening is positioned at a flat base of the hemispherical shape.

6. The method for making a smash cake, the method as claimed in claim 1 comprises the steps:
providing at least one themed item; and
placing the at least one themed item in addition to the plurality of confectioneries within the cake shell during step (E).

7. The method for making a smash cake, the method as claimed in claim 1 comprises the steps:
providing a pre-packaged box; and
retrieving the mallet, the mold, the quantity of shell-making material, and the plurality of confectionaries within the pre-packaged box during step (A).

8. The method for making a smash cake, the method as claimed in claim 1 comprises the steps:
providing a plurality of edible decorations; and
externally decorating the cake shell with the plurality of edible decorations before step (G).
